(19) United States
(12) Patent Application Publication
(10) Pub. No.: US 2008/0214410 A1
(43) Pub. Date: Sep. 4, 2008

(54) IMMOBILIZATION OF DISCRETE MOLECULES

(75) Inventors: Mingdi Yan, Lake Oswego, OR (US); Li Liu, Cambridge (GB); John Gann, Portland, OR (US)

Correspondence Address: KLARQUIST SPARKMAN, LLP, 121 SW SALMON STREET, SUITE 1600, PORTLAND, OR, 97204, US

(73) Assignee: State of Oregon Acting by and through the State Board of Higher Education on Behalf of Portland St

(21) Appl. No.: 11/775,190

(22) Filed: Jul. 9, 2007

Related U.S. Application Data
(60) Provisional application No. 60/819,409, filed on Jul. 7, 2006.

(51) Int. Cl. C40B 40/14; C40B 50/16

(52) U.S. Cl. 506/20; 506/31

(57) ABSTRACT

Embodiments of a method for covalently immobilizing one or more discrete molecules on a substrate and embodiments of substrates having covalently-immobilized discrete molecules are disclosed. Embodiments of the method can include exposing a substrate to a functionalizing reagent to form a functionalized substrate and exposing the functionalized substrate to a solution comprising the molecule to be immobilized. A reaction-energy source then can be used to activate the functionalizing reagent and covalently bond one or more of the molecules to the substrate. All or a substantial portion of the unbonded molecules then can be removed. Controlling the concentration of the functionalizing reagent to which the substrate is exposed allows the density of the bonding sites on the substrate to be reduced so that, after removal of the unbonded molecules, at least one of the bonded molecules remains on the substrate spatially isolated from any other bonded molecules.

### CROSS REFERENCE TO RELATED APPLICATION

This application claims the benefit of the earlier filing date of currently pending U.S. Provisional Application No. 60/819,409, filed Jul. 7, 2006, which is incorporated herein by reference.

### ACKNOWLEDGMENT OF GOVERNMENT SUPPORT

This invention was made with Government support under National Institutes of Health Academic Research Enhancement Award Number 1R15 GM066279-01A2. The United States Government has certain rights in the invention.

### FIELD

This disclosure concerns embodiments of a method for immobilizing discrete molecules, such as polymer molecules, on various substrates, and embodiments of products made by the method.

### BACKGROUND

Nano and molecular scale materials and devices have demonstrated great potential to offer unique properties and functions that are unattainable at macroscopic scales. To develop and manufacture such devices, it often is necessary to isolate single molecules. Studies of interactions and reactions involving single molecules, such as studies of single molecules under various physical measurement and chemical processing conditions, also have provided new perspectives on important issues in physics, chemistry, and biology. For these and other applications, it is desirable to immobilize single molecules on suitable substrates.

Electrostatic adsorption and chemical grafting are two approaches that have been used to immobilize single molecules on substrates. Electrostatic adsorption typically involves depositing a solution, typically a polymer solution, onto a substrate and then evaporating a solvent from the solution. In most cases, for the electrostatic interactions to occur, the molecule to be electrostatically immobilized and the substrate must possess opposite charges. This limits the number of polymer molecules available for immobilization. Chemical grafting typically involves functionalizing molecules, such as polymers, with a functional group and then conjugating the molecules to the substrates. Examples of known functionalized molecule and substrate combinations include Cl-terminated polydimethylsiloxane on silicon, disulfide-modified polystyrene on gold, and polysilanyllithium on brominated quartz.

### SUMMARY

Disclosed herein are embodiments of a method for immobilizing one or more discrete molecules on a substrate. Some of these embodiments include exposing a substrate to a functionalizing reagent to covalently bind the functionalizing reagent to the substrate. This forms a functionalized substrate, which then can be exposed to a solution of molecules to be immobilized. One or more molecules, such as polymer molecules, in the solution can couple, such as covalently, to the bonded functionalizing reagent while other molecules in the solution remain uncoupled. All or a substantial portion of the uncoupled molecules then can be removed such that at least one of the coupled molecules remains on the substrate spatially isolated from any other coupled molecules. To produce the desired density of immobilization sites on the substrate, the concentration of the functionalizing reagent in the solution applied to the substrate can be controlled. For example, in some embodiments, the substrate is exposed to a solution having a concentration of the functionalizing reagent between about 5×10⁻⁷ mg/mL and about 10 mg/mL.

The functionalizing reagent can be any compound that adheres to the substrate surface and promotes immobilization, such as covalent immobilization, of a molecule. In some embodiments, the functionalizing reagent includes one or more nitrenogenic group. For example, the functionalizing reagent can comprise a perhalophenylazide (PHPA), such as a perfluorophenylazide (PFPA). The coupled molecule can be a molecule that, polymer, such as polystyrene (PS), poly(2-ethyl-2-oxazoline) (PEOX) or poly(4-vinylpyridine) (PVP). The functionalizing reagent may be applied to the surface in concentrations of 5×10⁻⁷ mg/mL to 10 mg/mL, preferably concentrations of 5×10⁻⁴ mg/mL to 0.1 mg/ml. In embodiments in which the molecule is PS and the functionalizing reagent comprises a perfluorophenylazide, the substrate can be exposed to a solution having a perfluorophenylazide concentration between about 5×10⁻⁷ mg/mL and about 5×10⁻⁴ mg/mL. In embodiments in which the molecule is PEOX and the functionalizing reagent comprises a perfluorophenylazide, the substrate can be exposed to a solution having a perfluorophenylazide concentration between about 0.01 mg/mL and about 10 mg/mL. In embodiments in which the molecule is PVP and the functionalizing reagent comprises a perfluorophenylazide, the substrate can be exposed to a solution having a perfluorophenylazide concentration between about 5×10⁻⁴ mg/mL and about 5×10⁻¹ mg/mL.

In some embodiments, the functionalizing reagent in solution with other surface modifying reagents is applied to the substrate providing a mixed monolayer on the substrate. In these embodiments, substantially all of the available surface on the substrate occupied by either a functionalizing reagent or a surface modifying reagent. In some embodiments, the surface modifying reagents contain silicon moieties for interaction with the surface. For example, the surface modifying reagents can comprise N-(3-trimethoxysilylpropyl)-2,3,4,5,6-pentafluorobenzamide (PFB), n-propyltrimethoxysilane (PTMS) or n-octadecyltrimethoxysilane (ODTMS).

In other embodiments, the functionalizing reagent is activated on the functionalized substrate after exposing the functionalized substrate to the solution. For certain embodiments this requires spin-coating polymer onto the substrate, and heating above the glass transition temperature of the polymer. The functionalizing reagent can be exposed to a reaction energy source, such as ultraviolet (UV) light or thermal energy. After removing all or a substantial portion of the uncoupled molecules, a plurality of coupled molecules can remain on the substrate spatially isolated from each other and from any other coupled molecules. For example, at least one coupled molecule can be spatially isolated from any other coupled molecule by a distance greater than or equal to about 10 nm.

Also disclosed are embodiments of a discrete-molecule structure, such as a structure made by an embodiment of the disclosed method. The structure can include, for example, a substrate and a plurality of molecules, such as polymer molecules (e.g., PS and/or PEOX molecules), covalently bonded to the substrate via perhalophenylazides (e.g., perfluorophenylazides). In some embodiments, each molecule in the plurality of molecules is separated from other molecules on the substrate by a distance greater than about 10 nm. The substrate can comprise a variety of materials, such as silicon.

### BRIEF DESCRIPTION OF THE DRAWINGS

FIG. 1 is a schematic representation of one embodiment of a method for immobilizing a molecule on a substrate using PFPA-silane as the functionalizing reagent.

FIG. 2 is a X-ray photoelectron spectroscopy (XPS) graph of intensity versus binding energy measuring the fluorine 1s peak intensity as a function of solution concentration of N-(3-trimethoxysilylpropyl)-4-azido-2,3,5,6-tetrafluorobenzamide.

FIG. 3 is a graph of fluorine 1s peak intensity divided by the number of unsubstituted silicon sites versus concentration of a N-(3-trimethoxysilylpropyl)-4-azido-2,3,5,6-tetrafluorobenzamide/toluene solution.

FIG. 4 is a graph of the thickness and contact angle of PS deposited on silicon wafers functionalized with different concentrations of N-(3-trimethoxysilylpropyl)-4-azido-2,3,5,6-tetrafluorobenzamide.

FIG. 5A is an atomic force microscopy (AFM) image of a 1 μm×1 μm area of discrete PS molecules immobilized on a silicon wafer after treating the wafer with N-(3-trimethoxysilylpropyl)-4-azido-2,3,5,6-tetrafluorobenzamide at 5×10⁻⁵ mg/mL and then exposing the wafer to monodisperse PS (M_{W}=223,200).

FIG. 5B is am AFM image of a 1 μm×1 μm area of discrete PS molecules immobilized on a silicon wafer after treating the wafer with N-(3-trimethoxysilylpropyl)-4-azido-2,3,5,6-tetrafluorobenzamide at 1×10⁻⁵ mg/ml and then exposing the wafer to monodisperse PS (M_{W}=570,000).

FIG. 5C is an AFM image of a 1 μm×1 μm area of discrete PS molecules immobilized on a silicon wafer after treating the wafer with N-(3-trimethoxysilylpropyl)-4-azido-2,3,5,6-tetrafluorobenzamide at 5×10⁻⁶ mg/mL and then exposing the wafer to monodisperse PS (M_{W}=1,877,00).

FIG. 5D is the scale correlating height-to-color for FIGS. 3A-C.

FIG. 6 is an AFM topographic image of one of the discrete PS molecules shown in FIG. 5A.

FIG. 7 is a graph of PS film thickness versus the concentration of PFPA in a solution containing 12.6 mM of N-(3-trimethoxysilylpropyl)-4-azido-2,3,5,6-tetrafluorobenzamide and PFB in varying ratios, with the ratio of PFB:PFPA indicated above each bar.

FIG. 8 includes two graphs, wherein graph ‘a’ is a graph of PS film thickness versus the concentration of PFPA in a solution containing 12.6 mM of N-(3-trimethoxysilylpropyl)-4-azido-2,3,5,6-tetrafluorobenzamide and either PTMS or ODTMS in varying ratios, with the ratio of PTMS:PFPA or ODTMS:PFPA indicated above each bar; and graph ‘b’ is a graph of PS film thickness versus the photolinker density on the functionalized surface where the surface has been treated with mixtures of PFPA and either PTMS or ODTMS in solution.

FIG. 9A is an AFM image of discrete PS molecules immobilized on a silicon wafer by a mixed monolayer process.

FIG. 9B is the scale correlating height-to-color for FIG. 9A.

FIG. 10A is an AFM image of a 3 μm×3 μm area of discrete PEOX molecules immobilized on a silicon wafer after treating the wafer with N-(3-trimethoxysilylpropyl)-4-azido-2,3,5,6-tetrafluorobenzamide at 5×10⁻¹ mg/mL and then exposing the wafer to polydisperse PEOX (weight average M_{W}=500,000).

FIG. 10B is the scale correlating height-to-color for FIG. 10A.

FIG. 11A is an AFM image of discrete PS molecules immobilized on a silicon wafer, including one extended PS molecule.

FIG. 11B is the scale correlating height-to-color for FIG. 11A.

FIG. 12 is a graph of film thickness versus concentration of polystyrene measured on a silicon oxide substrate treated with 3 mg/mL N-(3-trimethoxysilylpropyl)-4-azido-2,3,5,6-tetrafluorobenzamide and soaked in solutions of varying polystyrene content.

FIG. 13 is a graph of contact angle for a water droplet on the surface versus concentration of polystyrene measured on a silicon oxide substrate treated with 3 mg/mL N-(3-trimethoxysilylpropyl)-4-azido-2,3,5,6-tetrafluorobenzamide and soaked in solutions of varying polystyrene content.

### DETAILED DESCRIPTION

The following definitions are provided to aid the reader, but are not intended to limit the defined terms to a scope less than would be understood by a person of ordinary skill in the art:

A “functional group” is a group of one or more atoms bonded together in an organized way so as to have particular chemical and/or physical properties.

A “functionalized substrate” is a substrate to which one or more molecules comprising one or more functional groups other than those naturally present on the substrate surface are adhered, covalently or otherwise. A “covalently-functionalized substrate” is a substrate to which one or more molecules comprising one or more functional groups other than those naturally present on the substrate surface are adhered covalently.

A “functionalizing reaction” is a reaction in which a substrate surface is functionalized with one or more functional groups other than those naturally present on the substrate surface. For example, a substrate surface may be functionalized with nitrenogenic groups to provide an azide-functionalized substrate. A functionalizing reaction can include one or more stages. At least one stage can include the reaction of a functional group of a functionalizing reagent with the surface of the substrate.

A “functionalizing reagent” is a reagent adapted for functionalizing a substrate. Some functionalizing reagents have at least one nitrenogenic group (as a first functional group) coupled, either directly or indirectly, to at least a second functional group. For example, in some functionalizing reagents the nitrenogenic group is not directly coupled to the second functional group, but is constrained by the molecular structure of the functionalizing reagent between the nitrenogenic group and the second functional group. The second functional group of the functionalizing reagent, which also can be a nitrenogenic group, can serve to couple the functionalizing reagent to a substrate. Thus, selection of a functional group can depend on the chemical composition of the substrate. Examples of functional groups that may be used to couple the functionalizing reagent to the substrate include, without limitation, thiols, amines, and silanes. Additional functional groups may be present on the functionalizing reagent and may serve to alter the properties of the functionalized substrate or to permit immobilization of additional molecules on the substrate. In some disclosed functionalizing reagents having a nitrenogenic group, additional functional groups can be constrained structurally from reacting with the nitrene moiety after the nitrene moiety is generated. Examples of additional functional groups include, without limitation:

(a) carboxyl groups and various derivatives thereof, such as (but not necessarily limited to): N-hydroxysuccinimide esters; N-hydroxybenzotriazole esters; acid halides corresponding to the carboxyl group; acyl imidazoles; thioesters; p-nitrophenyl esters; alkyl, alkenyl, alkynyl and aromatic esters, including esters of biologically active (and optically active) alcohols, such as cholesterol and glucose; various amide derivatives, such as amides derived from ammonia, and primary and secondary amines, including biologically active (and optically active) amines, such as epinephrine, L-dopa, enzymes, antibodies, and fluorescent molecules;

(b) hydroxyl and sulfhydryl groups, either free or esterified to a suitable carboxylic acid, which could be, for example, a fatty acid, a steroid acid, or a drug such as naprosin or aspirin;

(c) haloaliphatic groups, such as haloalkyl groups, wherein the halide can be later displaced with a nucleophilic group such as a carboxylate anion, thiol anion, carbanion, or alkoxide ion, thereby resulting in the covalent immobilization of a new group at the site of the halogen atom;

(d) maleimido groups and other dienophilic groups such that the group may serve as a dienophile in a Diels-Alder cycloaddition reaction with a 1,3-diene-containing molecule such as, for example, an ergosterol;

(e) aldehydes, ketone and sulfone groups, such that subsequent derivatization is possible via formation of well-known carbonyl derivatives such as hydrazones, semicarbazones, or oximes, or via such mechanisms as Grignard addition or alkyllithium addition; and

(f) sulfonyl halide groups for subsequent reactions with amines, for example, to form sulfonamides.

(g) aliphatic moieties, such as a hydrocarbon or hydrocarbon chain, lower (fewer than 10 carbon atoms) alkyl groups, such as methyl and ethyl, or a carbonyl bearing moiety, such as an aldehyde, ketone or ester. The hydrocarbon chain may be saturated or unsaturated; interrupted by heteroatoms such as N, O and/or S; contain saturated or unsaturated cyclic structures, in the chain or pendent to the chain, with or without heteroatoms; or contain other functional groups including by way of example and without limitation, hydroxyls, amines, aldehydes, carboxylic acids, esters, ethers, epoxides, ketones, thiols, sulfides, phosphines and phosphates.

In some disclosed embodiments, the functionalizing reagent is a functionalized aryl azide, an alkyl azide, an alkenyl azide, an alkynyl azide, an acyl azide, an azidoacetyl, or a derivative or combination thereof. All such reagents are capable of carrying a variety of functional substituents that serve to couple the functionalizing reagent to a substrate, provide sites where additional molecules may be coupled to the functionalizing reagent, or otherwise alter the chemical and/or physical properties of the functionalized substrate. In functionalizing reagents including an azido group halogen atoms may be present to the maximum extent possible in the positions on the functionalizing reagent molecule adjacent the azido group. Suitable halogen atoms include fluorine and/or chlorine.

Particularly effective functionalizing reagents may be derived from perhalophenylazides (PHPAs), particularly perfluorophenylazides (PFPAs). These compounds typically can be derived from 4-azido-2,3,5,6-tetrafluorobenzoic acid. For example, Schemes 1, 2, 3, and 4 below illustrate synthetic routes to a variety of functionalizing reagents based upon 4-azido-2,3,5,6-tetrafluorobenzoic acid. Functionalizing reagents may be referred to by a reference to the portion that interacts with the target molecule and the portion that interacts with the substrate. For example, where the amide linkage terminates in a silane, a PFPA may be referred to as PFPA-silane. Different PFPAs can be selected for a given application. For example, the PFPA form in Scheme 5 below is particularly useful for immobilizing single molecules on gold and other metallic substrates.

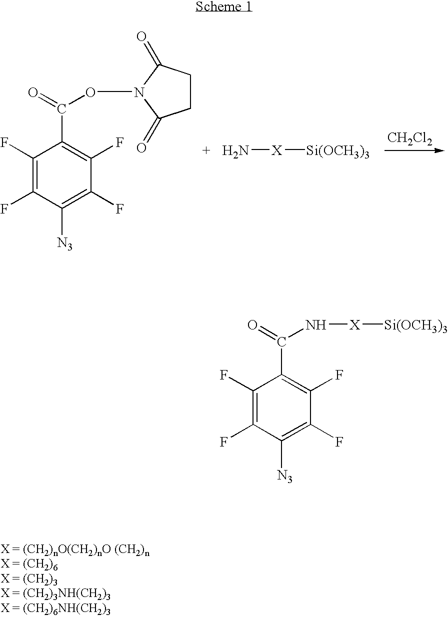

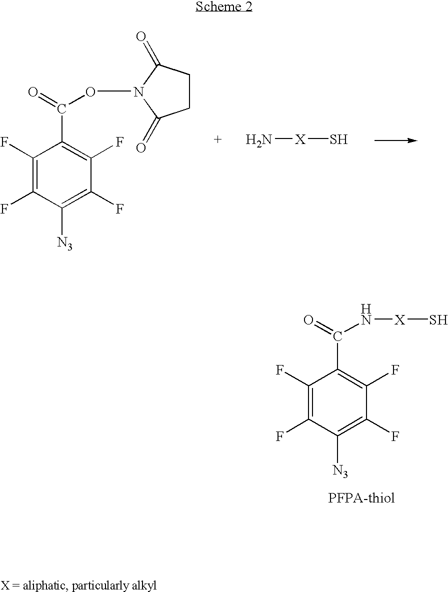

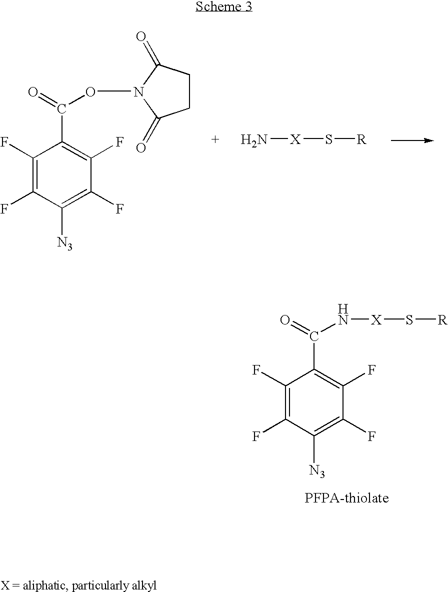

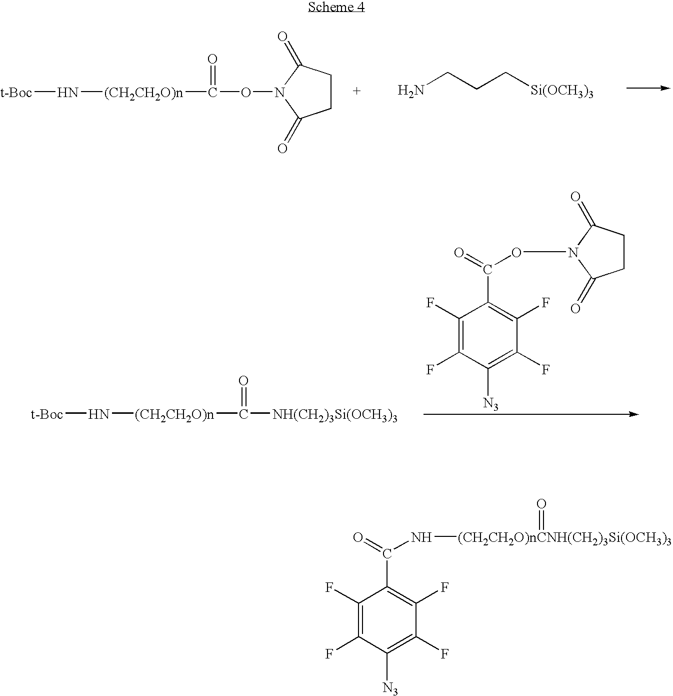

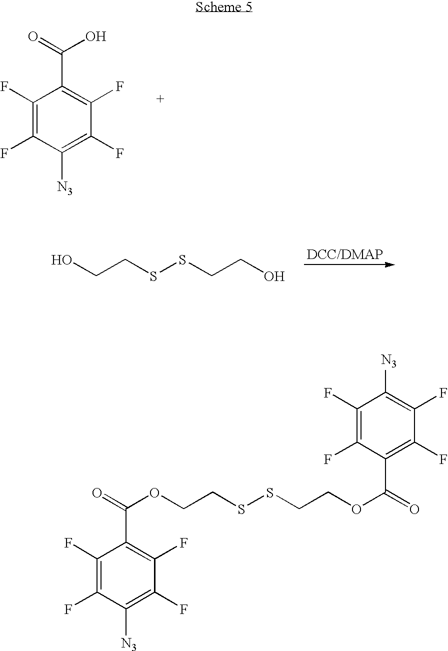

A person of ordinary skill in the art will recognize that the illustrated compounds, particular reactions, and any reaction conditions indicated above are illustrative of more general routes to the formation of such functionalizing reagents. For example, the compounds illustrated above all are fluorides, but other halides and mixtures of halides also may be useful compounds. Other examples include dihalophenylazides where two halogen atoms (F or (Cl) are ortho to the azido group.

The terms “immobilized” means effectively coupled. Portions of a molecule that is immobilized may still be movable, but the overall molecule is effectively coupled to another structure (e.g., a substrate) at least one point. Molecules can be immobilized, for example, by covalent bonding, non-covalent binding or electrostatic interaction.

A “nitrene group” (also generally termed “nitrene” or “nitrene intermediate”) is a particular form of nitrogen group regarded by persons of ordinary skill in the art as the nitrogen analogs of carbenes. Like carbenes, nitrenes are generally regarded as intermediates that are highly reactive and may not be isolatable under ordinary conditions. Important nitrene reactions include (but are not limited to) addition or insertion into C—H, N—H, O—H, and C—C bonds (single and double).

A “nitrenogenic group” is a chemical moiety that becomes a nitrene group when exposed to a reaction-energy source. An azido group is an example of a nitrenogenic group.

A “surface modifying reagent” is a reagent that is adapted for attaching to a substrate either covalently or non-covalently and is not further reactive under the conditions required to activate the functionalizing reagents toward target molecules. Such reagents attach to the substrate through a functional group. Examples of functional groups that may be used to couple the surface modifying reagent to the substrate include, without limitation, thiols, amines, and silanes. Additional functional groups may be present and may serve to alter the properties of the functionalized substrate.

A “polymer” is a compound formed by covalently linking smaller molecules termed “monomers.” The monomers present in a polymer molecule can be the same or different. If the monomers are different, the polymer also may be called a co-polymer. Polymer molecules can be natural, such as, but not limited to, carbohydrates, polysaccharides (such as celluloses and starches), proteins (such as enzymes), and nucleic acids; or synthetic, such as, but not limited to, nylon and polyaliphatic materials, particularly polyalkylene materials, examples of which include polyethylene and polypropylene. In a polymeric material, polymer molecules can be associated with each other in any of several ways, including non-covalently (as a thermoplastic) or by a covalently cross-linked network (as a thermoset).

Polymeric materials compatible with the disclosed method include virtually any polymeric material comprising polymer molecules possessing —CHI groups and/or —NH groups, and/or —OH groups, and/or C═O groups, and/or C═N groups, and/or carbon-carbon single bonds, and/or carbon-carbon double bonds, and/or carbon-carbon triple bonds. Such polymeric materials include, but are not limited to:

(a) saturated polyolefins, as exemplified by polyethylene, polyvinyl chloride, polytetrafluoroethylene, polypropylene, polybutenes, and copolymers thereof;

(b) acrylic resins, such as polymers and copolymers of acrylic acid, methacrylic acid, such as, poly(methylmethacrylate), poly(hexylmethacrylate), and acrylonitrile;

(c) polystyrene (PS) and its analogues, such as poly(p-chlorostyrene), poly(p-hydroxystyrene), and poly(alkylstyrene);

(d) unsaturated polyolefins, such as poly(isoprene) and poly(butadiene);

(e) polyimides, such as polyimide(benzophenone tetracarboxylic dianhydride/tetraethylmethylenedianiline);

(f) polyesters, such as poly(trimethylene adipate), poly(ethylene terephthalate), and poly(hexymethylene sebacate);

(g) conjugated and conducting polymers, such as poly(3-alkylthiophene), poly(3-alkylpyrrole), polyaniline, and poly(4-vinylpyridine) (PVP);

(h) inorganic polymers, such as poly(aryloxyphosphazene), poly(bis(trifluoroethoxy)), phosphazene, polysilanes, polycarbosilanes, siloxane polymers, and other silicon-containing polymers;

(i) organic metals (i.e., organic polymers with metallic properties) such as polycroconaines and polysquaraines, as described in Chemical and Engineering News (Aug. 31, 1992);

(j) organometallic polymers, such as palladium polyene and ferrocene-containing polyamides;

(k) polysaccharides, such as cellulose fibers, chitin, starch, glycogen, and glycosaminoglycans such as heparin, glucosamine, hyaluronic acid, chondroitin sulfate, and karatin sulfate;

(l) thermally responsive polymers, such as N-isopropylacrylamide (PNIPA), and co-polymers of PNIPA and poly(acrylic acid) or polyacrylamide;

(m) polypeptides, such as polylysine;

(n) polymers of cyclic amines, such as poly(2-ethyl-2-oxazoline) (PEOX) and poly(ethylenimine);

(o) polymers of nucleic acids, such as deoxyribonucleic acid (DNA) and ribonucleic acid (RNA);

(p) polyethers, such as poly(ethylene glycol) and poly(ethylene oxide).

A “reaction-energy source” is an energy source that promotes adherence of a molecule to a functionalized substrate, for example, by converting nitrenogenic groups on functionalizing reagent molecules to nitrenes, which may then react with, for example, a polymer molecule, or by directly adhering the molecule to a substrate. Suitable reaction-energy sources include (but are not limited to): photons, such as UV photons, deep-UV photons, laser light, X-rays, microwaves, thermal energy (such as infrared radiation and conductive heating), energized electrons (such as an electron beam), and energized ions (such as an ion beam). Reaction-energy sources can be used alone or in combination. Reaction-energy sources are conventionally used for such tasks as lithography, scanning microscopy and, in the case of UV and visible photons, effecting photochemical reactions and excitation of fluorescent molecules. A reaction-energy source comprising UV light can be supplied, for example, using a mercury or xenon lamp. A medium pressure mercury lamp is a source of photons between about 220 nm and about 1,000 nm, with a maximal intensity at about 360 nm. A photomask may be used to prevent photons from reaching certain portions of a sample while allowing photons to reach other portions.

A reaction-energy source comprising electrons can be supplied to a reaction by irradiating a sample under vacuum using an electron or particle beam. The energy of the electron or particle beam can be, for example, from about 1 kV to about 40 kV. A representative electron-beam source is a JEOL 840A electron microscope modified for electron-beam lithography. The beam may be stepped across the surface of a treated substrate to expose certain areas and not others. A dwell time at each step can be adjusted to change the exposure.

A thermal energy reaction-energy source can be supplied, for example, by heating a sample in an oven, typically ramped at a desired rate to a preselected working temperature or preheated to a designated temperature. Where the molecule to be immobilized is a polymer, the designated temperature can be a temperature sufficient to increase the polymer chain mobility. The designated temperature can vary depending on the given polymer-type. For example, the temperatures can be greater than the glass transition temperatures of the polymers being immobilized on the substrate, such as temperatures from about 120° C. to about 190° C., but less than the ignition temperatures of the polymers. The heating time can be a time sufficient to impart the necessary energy to bond the molecules to the substrate, such as between about 5 minutes and about 40 minutes.

A “substrate” typically is a non-fluid material providing a surface that can be functionalized. A substrate can comprise, for example, polymer molecules (e.g. thermoplastic polymer molecules), a thermoset molecular network (e.g., cross-linked polymer molecules), metal atoms (e.g., copper, gold, aluminum, platinum, palladium, and silver), semiconductor materials (e.g., gallium arsenide, silicon nitride, titanium dioxide, and cadmium sulfide), silicon, silica, glass, mica, quartz, clay, calcite (and other atomic or molecular associations such as found in certain glasses and crystals), and graphite (and other forms of carbon such as fullerenes, carbon electrodes, and carbon nanotubes). It also should be understood that a first material may be adhered to a first substrate to provide a second substrate to which additional materials may be adhered, and so on. The substrate can be a device comprising multiple layers of materials, for example a microelectronic device.

A substrate can be functionalized by interaction between functional groups on the functionalizing reagent or surface modifying reagent molecules and the substrate or substrate surface to couple the functionalizing reagent molecules to the substrate. Typically, the functional group on the functionalizing reagent molecule is either attracted to (e.g., by dipole-dipole interactions) or bonded (e.g., by hydrogen bonds, ionic bonds, or covalent bonds) to the substrate surface. Examples of molecules or materials that may be immobilized on a substrate include, without limitation, proteins, nucleic acids, carbohydrates, organometallic catalysts, polymers, peptides, and metals.

Unless otherwise explained, all technical and scientific terms used herein have the same meaning as commonly understood by one of ordinary skill in the art to which this disclosure belongs. The singular terms “a,” “an,” and “the” include plural referents unless the context clearly indicates otherwise. Similarly, the word “or” is intended to include “and” unless the context clearly indicates otherwise. The term “includes” means “comprises.” The method steps described herein can be partial, substantial or complete unless indicated otherwise.

The following terms may be abbreviated in this disclosure as follows: atomic force microscopy (AFM), kilovolt (kV), micrometer (μm), milligram (mg), milliliter (mL), millimolar (mM), N-isopropylacrylamide (PNIPA), nanometer (nm), perfluorophenylazide (PFPA), perhalophenylazide (PHPA), poly(2-ethyl-2-oxazoline) (PEOX), polystyrene (PS), revolutions per minute (rpm), scanning probe microscopy (SPM), ultraviolet (UV), and weight average molecular weight (M_{W}).

Disclosed herein are embodiments of a method for immobilizing, such as covalently, one or more discrete molecules, such as polymer molecules, on a substrate and embodiments of a discrete-molecule structure. Some embodiments of the disclosed method do not require chemical functionalization of the molecule and can be applied to molecules that do not include highly reactive functional groups. Rather than functionalizing the molecule, some disclosed embodiments include functionalizing the substrate. It has been discovered that functionalizing a substrate with a dilute solution of a functionalizing reagent can produce immobilization sites that are spatially distributed across the substrate surface. Due to the space between the immobilization sites, single molecules can be coupled to the substrate surface in isolation from other coupled molecules. Larger molecules in a polydisperse solution typically are immobilized more readily than smaller molecules.

Rather than limiting the density of immobilization sites on the substrate surface, some embodiments achieve single molecule immobilization by limiting the concentration of the molecule to be immobilized. For example, a substrate surface can be functionalized using a solution having a high concentration of functionalizing reagent to produce a substrate with an excess of immobilization sites. This substrate then can be exposed to a dilute solution of the molecule to be immobilized such that, when the diluent is removed, single molecules are immobilized on the substrate. In still other embodiments, the concentration of the functionalizing reagent solution and the concentration of the solution of the molecule to be immobilized are selected jointly to result in immobilization of discrete molecules.

In addition to polymer molecules, some embodiments of the disclosed method can be used to immobilize other types of compounds and/or structures. For example, some embodiments can be used to immobilize pharmaceutical compounds and/or discrete biological structures, such as cells. A person of ordinary skill in the art will recognize that the functionalizing reagent can be selected to react with a particular molecule or structure to be immobilized on the substrate.

The functionalizing reagent used with embodiments of the disclosed method can include one or more nitrenogenic group. Such functionalizing reagents often can be immobilized on a molecule, such as a polymer molecule, by applying a reaction-energy source. For example, UV light or thermal energy can be used to induce C—H/N—H insertion reactions. These and other functionalizing reagents also can include a functional group that allows the functionalizing reagent to couple to a substrate surface, such as by covalently bonding. Suitable functional groups for this purpose vary depending on the composition of the substrate. For example, functionalizing reagents suitable for coupling to a silicon substrate typically include a silicon-containing functional group. As discussed above, PHPAs, such as PFPAs, are particularly effective functionalizing reagents for use in embodiments of the disclosed method.

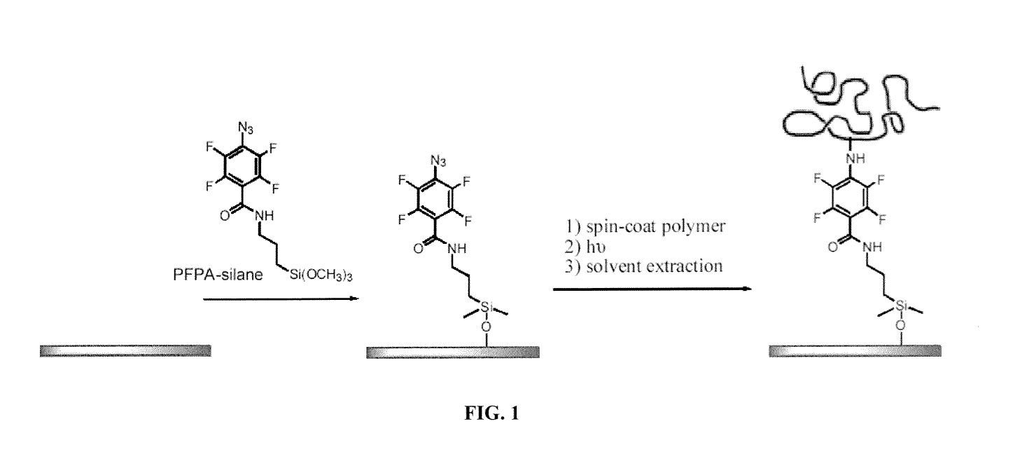

One example of an immobilization process based on photochemically or thermally initiated C—H/N—H insertion reactions of PHPAs is shown in FIG. 1. In the illustrated example, a substrate, such as a glass or silicon wafer, first is treated with a PFPA-silane. The silane can covalently bond to the glass substrate by reaction with oxygen and/or hydroxyl groups. This effectively couples —N₃ groups to the substrate. A solution comprising the molecule to be immobilized, such as a polymer molecule, then is coated onto the surface and the azido groups are activated, such as by applying a reaction energy source, to form covalent linkages to the molecules. This general method of immobilization has been found to be highly reproducible and defect-tolerant. Additional details regarding related covalent immobilization chemistry can be found in U.S. Pat. Nos. 5,465,151, 5,580,697, 5,582,955, 5,587,273, 5,830,539 and 6,022,597 and U.S. Patent Publication No. 2004/0242023, each of which is incorporated herein by reference.

In some disclosed embodiments, the functionalizing reagent is introduced onto the substrate in a solution. To immobilize discrete molecules, the density of immobilization sites on the substrate surface can be limited. One method for controlling immobilization site density is by varying the concentration of the functionalizing reagent in the solution to which the substrate is exposed. For example, the solution can be diluted with a solvent or the solution can be made with a mixture of active and non-active species (e.g., PFPA-silane and nonphotoactive silane). The more dilute the solution, the lower the density of immobilization sites.

The density of immobilized molecules achieved using a given concentration of functionalizing reagent depends on several factors, including the immobilization efficiency of the molecules. Typically, a lower concentration of functionalizing reagent is used to immobilize discrete molecules if the molecule is characterized by high immobilization efficiency. In contrast, a higher concentration of functionalizing reagent is used to immobilize discrete molecules if the molecule is characterized by low immobilization efficiency. By way of theory, molecules, such as polymers, having high immobilization efficiencies may have higher concentrations at the surface of a functionalized substrate than molecules having low immobilization efficiencies.

The density of immobilized molecules also may depend on the molecular weight of the molecules. Using the same concentration of functionalizing reagent, a molecule having a high molecular weight typically will be immobilized on a substrate at a higher density than a molecule having a low molecular weight. By way of theory, this may be because high molecular weight molecules have a greater number of bonding sites than low molecular weight molecules. If only one bond is required to immobilize an entire molecule, molecules having a greater number of bonding sites will immobilize more readily than molecules having fewer bonding sites.

The concentration of the functionalizing reagent in some disclosed embodiments is between about 5×10⁻⁷ mg/mL and about 10 mg/mL, such as between about 1×10⁻⁶ mg/mL and about 1 mg/mL, or between about 5×10⁻⁶ mg/mL and about 1 mg/mL. For the immobilization of PS, the concentration of the functionalizing reagent can be, for example, between about 5×10⁻⁷ mg/mL and about 5×10⁻⁴ mg/mL, such as between about 1×10⁻⁶ mg/mL and about 1×10⁻⁴ mg/mL, or between about 5×10⁻⁶ mg/mL and about 5×10⁻⁵ mg/mL. For the immobilization of PEOX, the concentration of the functionalizing reagent can be, for example, between about 0.01 mg/mL and about 10 mg/mL, such as between about 0.05 mg/mL and about 5 mg/mL, or between about 0.1 mg/mL and about 1 mg/mL. For the immobilization of PVP, the concentration of the functionalizing reagent can be, for example, between about 0.5 mg/mL and about 5×10⁻⁴ mg/mL.

Using embodiments of the disclosed method, the density of molecules, such as polymer molecules, immobilized on a substrate can be controlled. In some embodiments, at least one molecule is immobilized on a substrate surface spatially isolated from other immobilized molecules (if any) by a distance greater than or equal to about 10 nm, such as a distance greater than or equal to about 20 nm or a distance greater than or equal to about 50 nm. The maximum distance is unlimited because, in some circumstances only a single molecule will be immobilized on a given substrate.

Embodiments of the disclosed method can be used for a variety of purposes. For example, single molecules can be immobilized on a substrate for participation in reactions. Such reactions then can be studied at the molecular scale. Reaction of immobilized single molecules also can be used to form structures. For example, immobilized molecules can be combined with other molecules to form molecular-scale structures. After formation, such structures can be left in place or liberated from the substrate by breaking one or more bonds in the molecule or the functionalizing reagent.

### EXAMPLES

The following examples are provided to illustrate certain particular embodiments of the disclosure. Additional embodiments not limited to the particular features described are consistent with the following examples. The samples described in these examples were imaged in air using a multimode SPM Nanoscope III (Veeco) in tapping mode.

### Example 1

### Substrate Treatment with N-(3-Trimethoxysilylpropyl)-4-azido-2,3,5,6-tetrafluorobenzamide

This example concerns the preparation of substrate with reactive nitrogenic sites where the density of those sites is controlled by solution concentration of N-(3-trimethoxysilylpropyl)-4-azido-2,3,5,6-tetrafluorobenzamide.

First, silicon wafers were prepared and reacted with varying concentrations of N-(3-trimethoxysilylpropyl)-4-azido-2,3,5,6-tetrafluorobenzamide. Silicon wafers with a ˜70 nm thermally grown oxide layer (from Silicon Valley Microelectronics Inc.) were cut with a diamond pen and cleaned with 7:3 v/v concentrated H₂SO₄/35 wt % H₂O₂ for 1 hour at 80-90° C., washed thoroughly with boiling water for 1 hour, and dried under a stream of nitrogen. Cleaned wafers were soaked in solutions of N-(3 trimethoxysilylpropyl)-4-azido-2,3,5,6-tetrafluorobenzamide in toluene at concentrations ranging from 0.002 mM to 1.145 mM for 4 hours at room temperature. This process was carried out in sealed vials to minimize contact with moisture in the air. The treated wafers were rinsed with a gentle stream of toluene, dried under nitrogen, and then allowed to cure at room temperature for at least 24 hours.

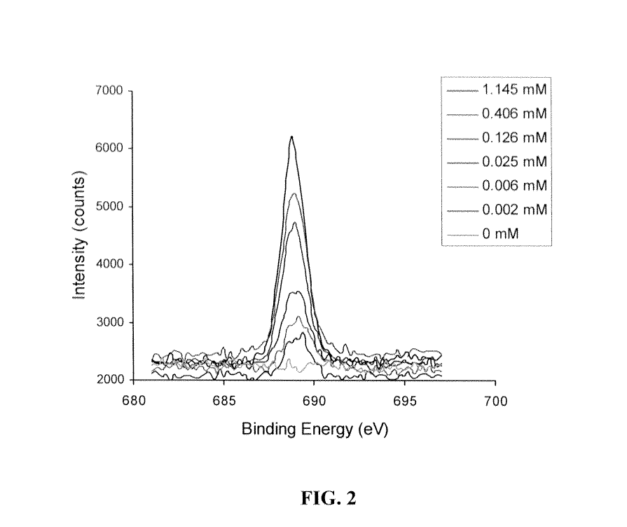

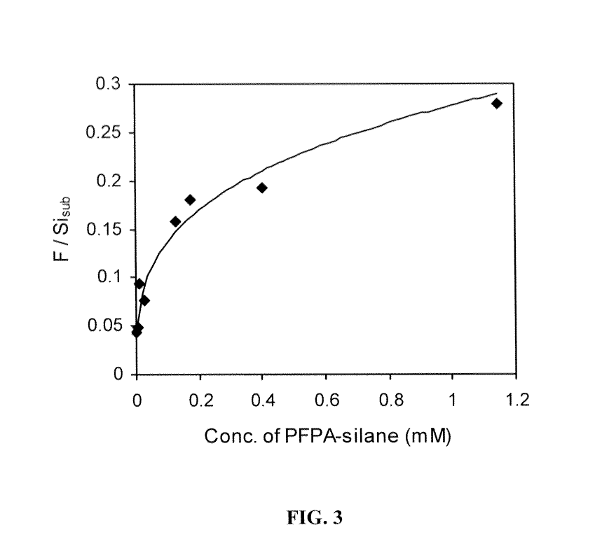

Subsequently, the treated wafers were analyzed with XPS. This analysis showed that the intensity due to the fluorine 1s peak was dependent on the concentration of the N-(3-trimethoxysilylpropyl)-4-azido-2,3,5,6-tetrafluorobenzamide solution that was used to treat the wafer. See FIG. 2. XPS measurements were performed with an Al Kα x-ray source at 1486.7 eV for excitation and a spherical section analyzer. The X-ray beam used was a 101.5 W, 100 μm diameter beam that was rastered over a 1.4 mm by 0.2 mm rectangle on the sample. The X-ray beam was incident normal to the sample while the photoelectron detector was set at an angle of 45° from the normal. The binding energy (BE) scale was calibrated using the Cu 2p 3/2 feature at 932.62±0.05 eV and Au 4f at 83.96±0.05 eV. XPS data was converted to give the density of functionalized sites as a function of the solution of concentration of N-(3-trimethoxysilylpropyl)-4-azido-2,3,5,6-tetrafluorobenzamide. See FIG. 3.

### Example 2

### Immobilization of Polystyrene

This example concerns the immobilization of discrete molecules of polystyrene on silicon surfaces through the use of a perfluorinated phenyl azide.

Silicon wafers prepared as in Example 1 were treated for 5 minutes with solutions of N-(3-trimethoxysilylpropyl)-4-azido-2,3,5,6-tetrafluorobenzamide in toluene. The concentrations of N-(3-trimethoxysilylpropyl)-4-azido-2,3,5,6-tetrafluorobenzamide ranged from 5×10⁻¹ mg/mL to 5×10⁻⁵ mg/mL. After being treated with the N-(3-trimethoxysilylpropyl)-4-azido-2,3,5,6-tetrafluorobenzamide, the wafers were spin coated at 2000 rpm with a solution of PS (monodisperse, M_{w}=223,200) in toluene. The concentration of PS in the solution was 10 mg/mL. The samples then were irradiated with a medium pressure Hg lamp for 5 minutes followed by removal of the unbound polymer with toluene. This yielded covalently-immobilized polymer molecules. The thickness and water contact angles of the resulting films are shown in FIG. 4.

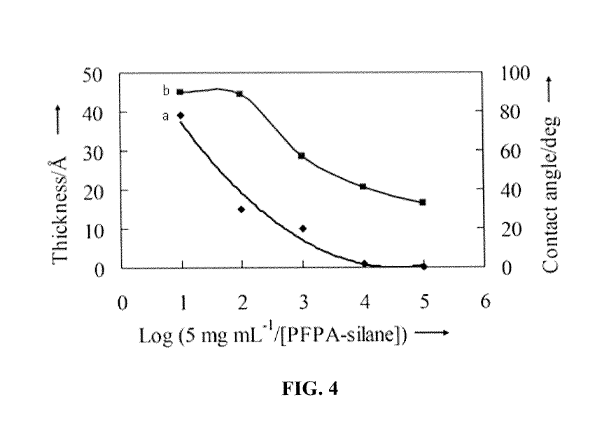

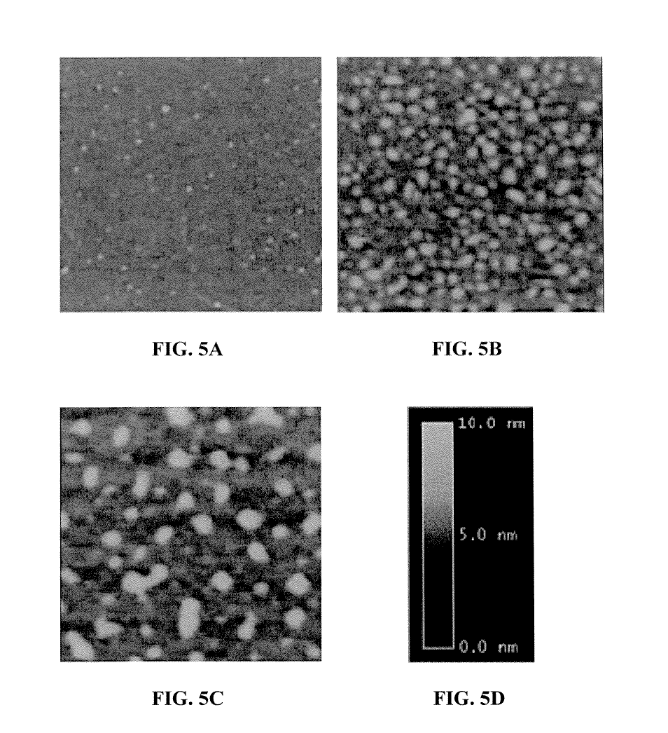

As the concentration of N-(3-trimethoxysilylpropyl)-4-azido-2,3,5,6-tetrafluorobenzamide decreased, the immobilized polymer film became thinner. Line “a” in FIG. 4 illustrates this trend. A contact angle of ˜89° corresponds to that of uniform PS films. As shown by line “b” in FIG. 4, at a N-(3-trimethoxysilylpropyl)-4-azido-2,3,5,6-tetrafluorobenzamide concentration of 5×10⁻³ mg/mL, the contact angle decreased to 57°, indicating that the film was no longer cohesive. Further dilution resulted in lower contact angles until no film was detected by ellipsometry. When immobilization was performed on wafers treated with N-(3-trimethoxysilylpropyl)-4-azido-2,3,5,6-tetrafluorobenzamide at 5×10⁻⁵ mg/mL, isolated single PS molecules were observed. To confirm that the observed particles were indeed single polymer molecules, PS of various molecular weights was tested. The results are shown in FIGS. 5A-C.

Polymer size is directly related to molecular weight (i.e., the higher the molecular weight, the larger the radius of gyration (R_{g}) and thus the size of the molecule). FIGS. 5A-C are AFM images of PS molecules having different molecular weights, M_{w}=223,200, 570,000, and 1,877,000, respectively. All of the PS samples were obtained from Scientific Polymer Products, Inc. FIGS. 5A-C show that the size of the immobilized single polymer molecules increased with the molecular weight of the polymer.

The wafers shown in FIGS. 5A-C were treated with 5×10⁻⁵, 1×10⁻⁵ and 5×10⁻⁶ mg/mL N-(3-trimethoxysilylpropyl)-4-azido-2,3,5,6-tetrafluorobenzamide, respectively. The higher the molecular weight, the lower the concentration of N-(3-trimethoxysilylpropyl)-4-azido-2,3,5,6-tetrafluorobenzamide needed to obtain single molecule immobilization. This is consistent with the immobilization chemistry shown in FIG. 1. Without being bound by a theory of operation, it appears that as the molecular weight, and thus size, of the polymer increases, less surface azido groups are needed to immobilize the polymer. The concentration of N-(3-trimethoxysilylpropyl)-4-azido-2,3,5,6-tetrafluorobenzamide in compositions used to spin coat the wafers was decreased with increasing molecular weight in order to obtain isolated single molecules.

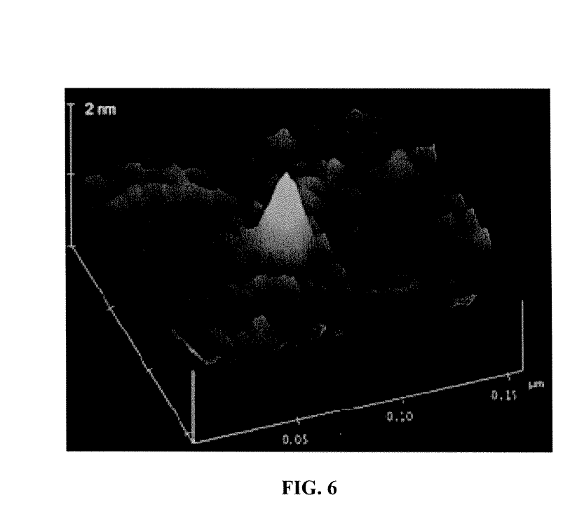

AFM revealed that, for certain disclosed working embodiments, the immobilized polystyrene adopted a cone shape (FIG. 6). The volume of a single polystyrene molecule (V) thus can be calculated according to the following equation:

$$V = \frac{1}{3} H {π ( \frac{D}{2} )}^{2}$$

where H is the height and D is the diameter of the molecule measured by AFM. Results showed that the measured values (V) were in good agreement with those calculated from the molecular weights of the polymer (V_{calc}) (Table 1).

TABLE 1
Measured and Calculated Sizes of Single PS Molecules

| M_{w} | D (nm) | H (nm) | V (nm³) | V_{calc} (nm³) |
|---|---|---|---|---|
| 223,200 | 32 ± 6 | 1.6 ± 0.6 | 429 | 370 |
| 570,000 | 50 ± 7 | 1.9 ± 0.5 | 1243 | 947 |
| 1,877,000 | 69 ± 14 | 2.7 ± 1.2 | 3364 | 3118 |

The D and H values in Table 1 for M_{w}=223,200 were measured and averaged from 112 immobilized molecules in FIG. 5A excluding obvious large aggregates. The D and H values in Table 1 for M_{w}=570,000 were measured and averaged from 85 immobilized molecules in FIG. 5B excluding obvious large aggregates. The D and H values in Table 1 for M_{w}=1,877,000 were measured and averaged from 51 immobilized molecules from FIG. 5C excluding obvious large aggregates.

### Example 3

### Substrate Treatment with N-(3-trimethoxysilylpropyl)-4-azido-2,3,5,6-tetrafluorobenzamide and a Surface Modifying Reagent

This example concerns the preparation of substrate with reactive nitrogenic sites where the density of those sites is controlled by selecting a ratio of N-(3-trimethoxysilylpropyl)-4-azido-2,3,5,6-tetrafluorobenzamide to surface modifying reagent in a solution where the total concentration of substrate reactive molecules is constant.

An alternative approach to altering the density of surface azido groups is to produce a mixed monolayer. The silicon wafers were prepared as in Example 1. Cleaned wafers were soaked in a solution of N-(3-trimethoxysilylpropyl)-4-azido-2,3,5,6-tetrafluorobenzamide and one other silane, selected from N-(3-trimethoxysilylpropyl)-2,3,4,5,6-pentafluorobenzamide (PFB), n-propyltrimethoxysilane (PTMS) or n-octadecyltrimethoxysilane (ODTMS) in toluene for 4 hours, at room temperature. The total concentration of the mixed silanes was kept at 12.6 mM. The molar ratio of surface modifying reagent to PFPA was varied from 10:1 to 500:1. This process was carried out in sealed vials to minimize contact with moisture in the air. The treated wafers were rinsed with a gentle stream of toluene, dried under nitrogen, and then allowed to cure at room temperature for at least 24 hours.

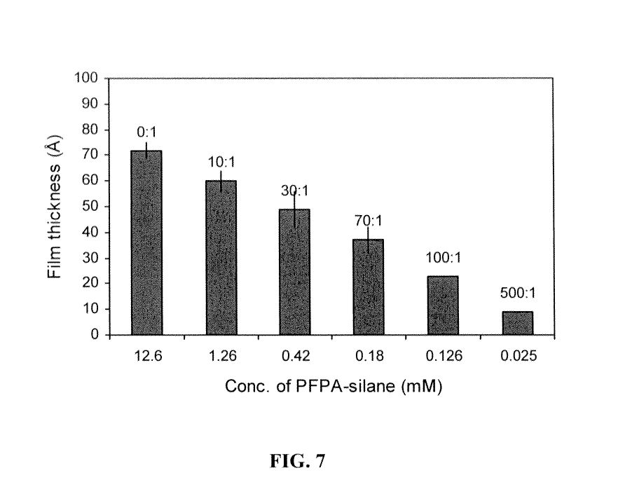

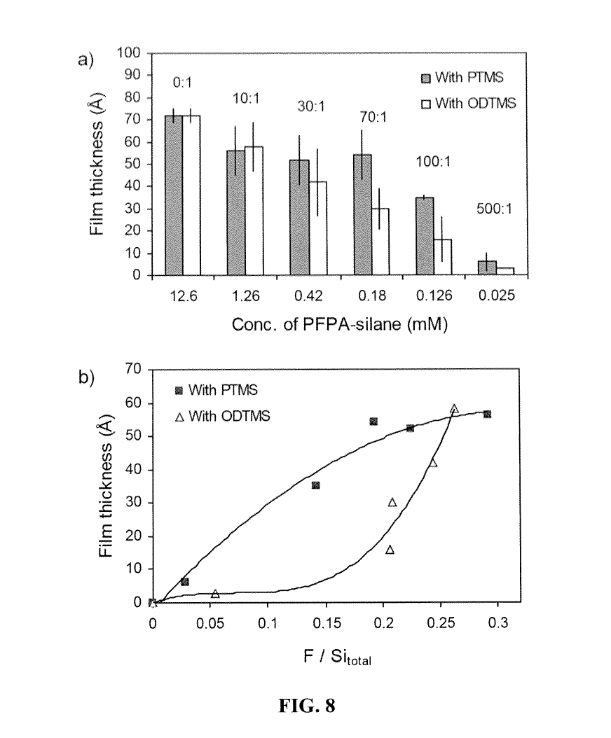

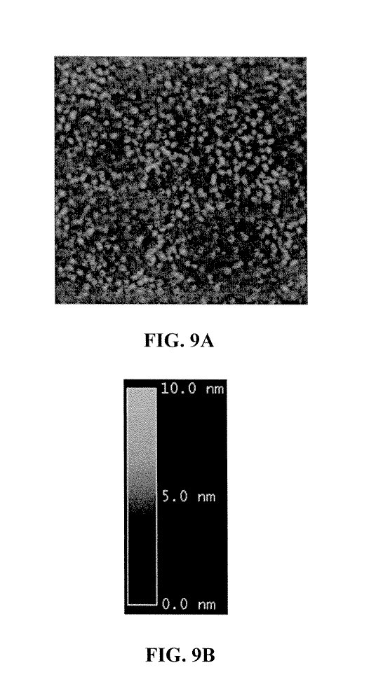

The mole ratio of the non-photoactive silane to N-(3-trimethoxysilylpropyl)-4-azido-2,3,5,6-tetrafluorobenzamide was increased to produce mixed monolayers with decreasing density of the surface azido groups. The resulting functionalized surface was spin-coated with polystyrene, irradiated, and the film thickness measured after the excess polymer was removed by toluene extraction (as in Example 2). The thickness of the film layer was evaluated by ellipsometry. As the ratio of PFB:PFPA increased (and hence the effective concentration of PFPA was decreased) the film thickness decreased. See FIG. 7. Similar results were observed for PTMS and ODTMS as surface modifying reagents. See FIG. 8. With ODTMS as the additive, single polymer molecules were observed at an ODTMS-to-N-(3-trimethoxysilylpropyl)-4-azido-2,3,5,6-tetrafluorobenzamide mole ratio of 500:1. The resulting surface was analyzed by AFM (FIG. 9).

### Example 4

### Covalent Immobilization of Poly(2-ethyloxazoline)

This example concerns the immobilization of discrete molecules of poly(2-ethyloxazoline) on a silicon surface through the use of a perfluoro phenyl azide.

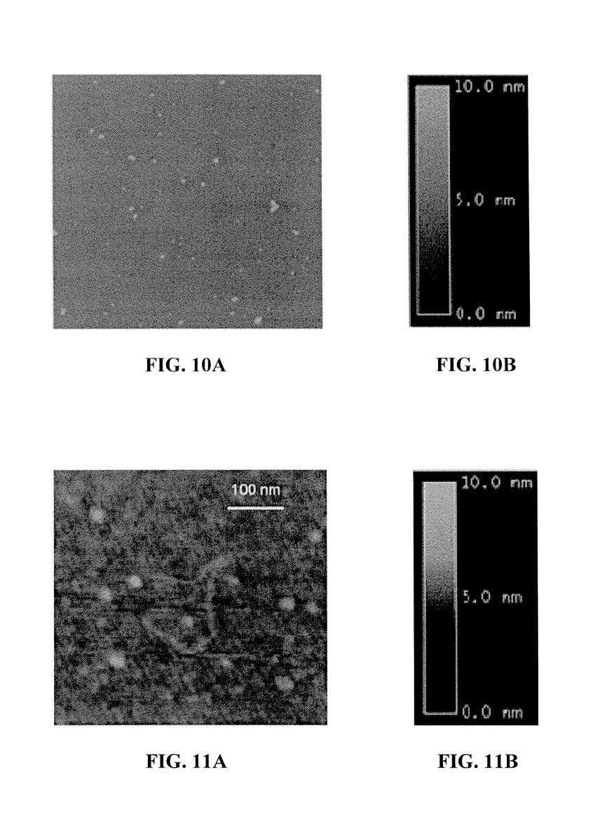

Following the procedure of Example 2, single molecules of PEOX were successfully immobilized (FIG. 10A). A much higher concentration of N-(3-trimethoxysilylpropyl)-4-azido-2,3,5,6-tetrafluorobenzamide was needed for PEOX than for PS. For example, a typical N-(3-trimethoxysilylpropyl)-4-azido-2,3,5,6-tetrafluorobenzamide concentration of 5×10⁻¹ mg/mL was used to produce single polymer molecules with PEOX, whereas a typical N-(3-trimethoxysilylpropyl)-4-azido-2,3,5,6-tetrafluorobenzamide concentration of 5×10⁻⁵ mg/mL was used to produce single polymer molecules with PS. By way of theory, the difference may be attributable to the difference in immobilization efficiency of the two polymers, which may be governed by the local concentration of each polymer in close proximity with the azide-functionalized surface.

Evaluation of 62 immobilized molecules from FIG. 10A yielded an average particle volume of 1,764 nm³ (D=53±8 nm, H=2.4±1.1 nm), whereas the calculated molecular volume was 830 nm³ based on the average molecular weight of the sample (M_{w}=500,000). Unlike PS samples, which were monodisperse, the PEOX obtained from Aldrich was polydisperse. A polydisperse polymer is more heterogeneous than its monodisperse counterpart with respect to molecular weight. When a polymer containing various sized molecules is coated on a surface having a limited number of azido groups, larger molecules, i.e., polymer molecules of higher molecule weight, are more likely than smaller molecules to be immobilized. By way of theory, this may explain why the molecular volume of the immobilized polymers was calculated to be larger than the theoretical value calculated from the average molecular weight of the original sample. This preferential immobilization of larger size polymers also was observed for PS (Table 1) although the deviations were smaller than for PEOX due to the monodisperse nature of the PS samples.

Extended single polymer chains were occasionally observed, as shown in FIG. 11A. The curvilinear length was measured to be about 430 nm. This value falls in the range of 95 to 953 nm calculated from the molecular weight distribution of the PS sample.

### Example 5

### Covalent Immobilization of Poly(4-vinylpyridine)

This example concerns the covalent immobilization of poly(4-vinylpyridine) on a silicon surface through the use of a perfluorinated phenyl azide.

Silicon wafers prepared as in Example 1 were treated for 5 minutes with solutions of N-(3-trimethoxysilylpropyl)-4-azido-2,3,5,6-tetrafluorobenzamide in toluene. The concentrations of N-(3-trimethoxysilylpropyl)-4-azido-2,3,5,6-tetrafluorobenzamide ranged from 5×10⁻¹ mg/mL to 5×10⁻⁵ mg/mL. After being treated with the N-(3-trimethoxysilylpropyl)-4-azido-2,3,5,6-tetrafluorobenzamide, the wafers were spin coated at 2000 rpm with a solution of PVP (monodisperse, M_{w}=160,000) in n-butanol. The concentration of PVP in the solution was 10 mg/mL. The samples then were irradiated with a medium pressure Hg lamp for 5 minutes followed by removal of the unbound polymer by sonication in n-butanol. This yielded covalently-immobilized polymer molecules. In order to assess changes in film properties with protonation of the pendant pyridine moieties; substrates with immobilized PVP were first analyzed as in Example 2, then soaked in 2M hydrochloric acid for 10 minutes and re-analyzed. The resulting film thicknesses are reported in Table 2.

TABLE 2
Measured and Calculated Sizes of Single PS Molecules

| Concentration of N-(3- | | |
|---|---|---|
| trimethoxysilylpropyl)-4-azido- | Thickness of | |
| 2,3,5,6-tetrafluorobenzamide | PVP Film | Thickness of PVP Film, |
| (mg/mL) | (Å) | With HCl (Å) |
| 5 × 10⁻¹ | 65 | 90 |
| 5 × 10⁻² | 48 | 73 |
| 5 × 10⁻³ | 9 | 15 |
| 5 × 10⁻⁴ | 8 | 2 |

### Example 6

### Layer Thickness and Immobilization of Polystryrene

This example concerns the effect of polymer solution concentration on the thickness of the polystyrene layer on a silicon surface after immobilization and washing.

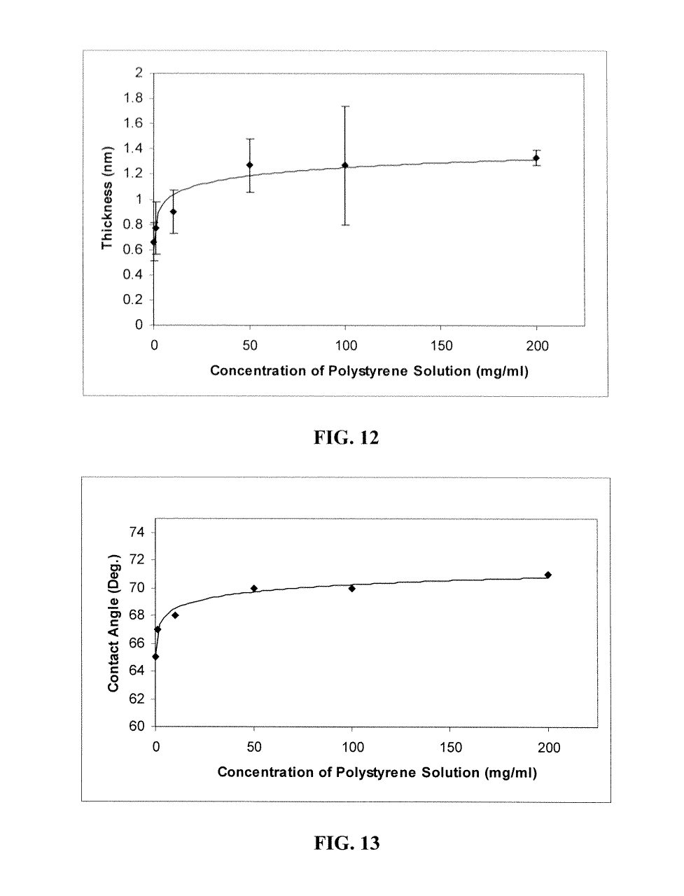

Silicon wafers cleaned according to Example 1 were soaked in a solution of N-(3-trimethoxysilylpropyl)-4-azido-2,3,5,6-tetrafluorobenzamide in toluene (3 mg/mL) for 24 hours. The wafers were then rinsed with a gentle stream of toluene and dried under nitrogen. The wafers were then allowed to cure for at least 24 hours before thickness measurements were made. Functionalized wafers were placed 8 mL of polystyrene (M_{W}=280,000) or poly(2-ethyl-2-oxazoline) in CHCl₃ in varying concentrations (ranging from 0.001-200 mg/mL), in small glass vessel with 280 nm optical filter placed on top. To establish equilibrium conditions, the samples were immersed in the polymer solution, covered and allowed to equilibrate for two days in the refrigerator before irradiation was carried out. Before the samples were irradiated they were allowed to warm to room temperature by placing them on the bench top for about one hour. The sample was irradiated for 15 minutes by a medium pressure Hg lamp. The wafer was then sonicated in fresh CHCl₃ for 5 minutes, to remove any unattached polymer, rinsed, and dried under nitrogen. Analysis of the resulting films showed a dependence of film thickness and hydrophobicity (via contact angle measurements) on concentration of polymer in solution. The shape of the isotherm (FIGS. 12 and 13) is typical for the adsorption of a polydisperse polymer onto a solid substrate.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method for immobilizing one or more discrete molecules on a substrate, comprising:
exposing a substrate to a functionalizing reagent to covalently bond the functionalizing reagent to the substrate;
exposing the substrate to a solution, wherein one or more molecules in the solution effectively couples to the bonded functionalizing reagent and other molecules in the solution remain uncoupled; and
removing all or a substantial portion of the uncoupled molecules such that at least one of the one or more coupled molecules remains on the substrate spatially isolated from any other coupled molecules.

2. The method according to claim 1, wherein the one or more coupled molecules comprises one or more polymer molecules.

3. The method according to claim 1, wherein the coupled molecules are covalently bonded to the functionalizing reagent.

4. The method according to claim 1, wherein exposing the substrate to the functionalizing reagent comprises exposing the substrate to a solution having a concentration of the functionalizing reagent between about 5×10⁻⁷ mg/mL and about 10 mg/mL.

5. The method according to claim 1, wherein effectively coupling the molecule in solution to the bonded functionalizing reagent comprises exposing the functionalizing reagent to ultraviolet light.

6. The method according to claim 1, wherein at least one of the one or more coupled molecules is polystyrene, the functionalizing reagent comprises a perfluorophenylazide, and exposing the substrate to the functionalizing reagent comprises exposing the substrate to a solution having a perfluorophenylazide concentration between about 5×10⁻⁷ mg/mL and about 5×10⁻⁴ mg/ml.

7. The method according to claim 1, wherein the at least one of the one or more coupled molecules is poly(2-ethyl-2-oxazoline), the functionalizing reagent comprises a perfluorophenylazide, and exposing the substrate to the functionalizing reagent comprises exposing the substrate to a solution having a perfluorophenylazide concentration between about 0.01 mg/mL and about 10 mg/mL.

8. The method according to claim 1, wherein at least one of the one or more coupled molecules is poly(4-vinylpyridine), the functionalizing reagent comprises a perfluorophenylazide, and exposing the substrate to the functionalizing reagent comprises exposing the substrate to a solution having a perfluorophenylazide concentration between about 5×10⁻⁴ mg/mL and about 5×10⁻¹ mg/mL.

9. The method according to claim 1 wherein exposing the substrate to the functionalizing reagent comprises exposing the substrate to a solution having a functionalizing reagent as well as a surface modifying reagent in a molar ratio from about 1:10 to about 1:500.

10. The method according to claim 9 wherein the functionalizing reagent is a perfluorophenylazide.

11. The method according to claim 9 wherein the surface modifying reagent is N-(3-trimethoxysilylpropyl)-2,3,4,5,6-pentafluorobenzamide.

12. The method according to claim 9 wherein the surface modifying agent is n-propyltrimethoxysilane.

13. The method according to claim 9 wherein the surface modifying agent is n-octadecyltrimethoxysilane.

14. The method according to claim 1, wherein the functionalizing reagent includes one or more nitrenogenic group.

15. The method according to claim 1, wherein a plurality of coupled molecules remain on the substrate spatially isolated from each other and from any other coupled molecules after removing all or a substantial portion of the uncoupled molecules.

16. The method according to claim 1, wherein the at least one of the one or more coupled molecules is spatially isolated from any other coupled molecules by a distance greater than or equal to about 10 nm.

17. The method according to claim 1, wherein the functionalizing reagent comprises a perhalophenylazide.

18. The method according to claim 1, wherein the functionalizing reagent comprises a perfluorophenylazide.

19. The method according to claim 1, further comprising activating the functionalizing reagent on the functionalized substrate after exposing the functionalized substrate to solution.

20. The method according to claim 17, wherein activating the functionalizing reagent comprises exposing the functionalizing reagent to a reaction energy source.

21. The method according to claim 20, wherein the reaction energy source is ultraviolet light.

22. The method according to claim 20, wherein the reaction energy source is thermal energy.

23. A method for forming isolated polymer molecules of a selected size and spacing on a substrate, comprising:
selecting a concentration of a functionalizing reagent in a functionalizing reagent solution to produce a predetermined spacing of polymer molecules bonded to a substrate;
exposing the substrate to a functionalizing reagent solution having the selected concentration of functionalizing reagent to form a functionalized substrate;
selecting a weight or number average molecular weight of polymer molecules to be bonded to the substrate to produce bonded polymer molecules having a predetermined size;
exposing the functionalized substrate to a solution comprising a polymer having the selected weight or number average molecular weight, wherein one or more of the polymer molecules in the solution couples to the functionalized substrate and other polymer molecules in the solution remain uncoupled; and
removing all or a substantial portion of the uncoupled polymer molecules such that at least one of the one or more coupled polymer molecules remains on the substrate spatially isolated from any other coupled polymer molecules.

24. A discrete-molecule structure, comprising:
a substrate; and
a plurality of molecules covalently bonded to the substrate via perhalophenylazides, wherein each molecule in the plurality of molecules is separated from other molecules on the substrate by a distance greater than about 10 nm.

25. The discrete-molecule structure according to claim 24, wherein the plurality of molecules comprises polymer molecules.

26. The discrete-molecule structure according to claim 24, wherein the plurality of molecules comprises polystyrene molecules.

27. The discrete-molecule structure according to claim 24, wherein the plurality of molecules comprises poly(2-ethyl-2-oxazoline) molecules.

28. The discrete-molecule structure according to claim 24, wherein the plurality of molecules comprises poly(4-vinylpyridine) molecules.

29. The discrete-molecule structure according to claim 24, wherein the plurality of molecules are covalently bonded to the substrate via perfluorophenylazides.

30. The discrete-molecule structure according to claim 24, wherein the substrate comprises silicon.
